(19) United States
(12) Patent Application Publication
(10) Pub. No.: US 2026/0028953 A1
(43) Pub. Date: Jan. 29, 2026

(54) Nitrogen Rejection System and Method

(71) Applicant: Yash Avi Singh, Westminster (CA)

(72) Inventor: Yash Avi Singh, Westminster (CA)

(21) Appl. No.: 19/282,671

(22) Filed: Jul. 28, 2025

Related U.S. Application Data
(60) Provisional application No. 63/676,439, filed on Jul. 29, 2024.

(51) Int. Cl. F02M 35/02; B01D 53/053

(52) U.S. Cl. CPC F02M 35/0218; B01D 53/053; B01D 2253/108; B01D 2256/12; B01D 2257/40; B01D 2259/4566

(57) ABSTRACT

The Nitrogen Rejection System (NRS) is a component that attaches to an internal combustion engine system to prevent nitrogen from entering the combustion chamber-thus reduce or eliminate NOx emissions and increase power production. A compressor draws in filtered atmospheric air (atmospheric air that has passed through the intake filter) and compresses it into a tank containing zeolite. This results in a tank of compressed concentrated oxygen which is then injected into the engine. In comparison to prior art zeolite systems in the intake manifold, the NRS can: (1) more accurately control the amount of oxygen produced; (2) produce oxygen more efficiently; and (3) produce compressed output-allowing for very high-power production potential.

### BACKGROUND OF THE INVENTION

Nitrogen oxides (NOx) are a group of highly reactive gases that contain nitrogen and oxygen. The two most important compounds in this group are nitric oxide (NO) and nitrogen dioxide (NO2). NOx emissions are a significant environmental concern due to their adverse effects on air quality, human health, and the environment. Internal combustion engines in vehicles such as cars, trucks, and buses produce NOx when burning fossil fuels. NOx emissions from internal combustion engines are generated from both the nitrogen present in the air (Thermal NOx) and the nitrogen in the fuel (Fuel NOx). NOx is produced when nitrogen (in the air or the fuel) and oxygen (in the air) react at high temperatures (above 1,300° C. or 2,372° F.).

Thermal NOx is formed when nitrogen (N₂) and oxygen (O₂) in the air react at high temperatures inside the combustion chamber. The formation of thermal NOx is highly temperature-dependent, increasing exponentially at temperatures above 2,800° F. (1,540° C.). Thermal NOx is generally the dominant source of NOx emissions in combustion engines, especially in high-temperature environments such as those found in spark-ignition (gasoline) engines and some types of diesel engines. Studies indicate that thermal NOx can account for 70-90% of total NOx emissions in such engines.

Fuel NOx is produced from the combustion of nitrogen-containing compounds in the fuel. It is particularly relevant for fuels like coal and heavy fuel oils that have higher nitrogen content. The nitrogen in the fuel reacts with oxygen during combustion to form NO and NO₂. The contribution of fuel NOx varies significantly based on the nitrogen content of the fuel. In diesel engines, where fuel typically contains about 0.1% nitrogen by weight, fuel NOx can contribute to 10-30% of total NOx emissions. In contrast, for fuels with higher nitrogen content, such as some types of coal and heavy fuel oils, fuel NOx can be a more significant portion of total NOx emissions.

A three-way catalytic converter (TWC) is an emission control device used in gasoline-powered vehicles to reduce harmful exhaust emissions. It is called “three-way” because it simultaneously reduces three types of pollutants: nitrogen oxides (NOx), carbon monoxide (CO), and unburned hydrocarbons (HC). A well-functioning TWC can reduce NOx emissions by approximately 70-90%.

A three-way catalytic converter consists of a substrate and a catalyst. A substrate is a ceramic or metallic honeycomb structure that provides a large surface area for the catalytic reactions. Coatings of precious metals such as platinum (Pt), palladium (Pd), and rhodium (Rh) are applied to the substrate. These coatings are the catalyst. These metals facilitate the chemical reactions that convert harmful emissions into less harmful substances. For optimal performance, the engine's air-fuel ratio must be precisely controlled. A stoichiometric air-fuel ratio ensures that there is just enough oxygen to complete these reactions efficiently. The vehicle's engine control unit (ECU) monitors and adjusts the air-fuel mixture to maintain this ratio using oxygen sensors.

There are several limitations of three-way catalytic converters.
Sensitivity to Air-Fuel Ratio: The TWC operates efficiently only at or near the stoichiometric air-fuel ratio. Deviations from this ratio (too rich or too lean mixtures) can reduce its effectiveness.
Cold Start Emissions: During a cold start, the engine and catalytic converter are not at their optimal operating temperatures. The catalytic converter requires heat to activate the catalyst, so it is less effective at reducing emissions immediately after startup.
Sulfur Sensitivity: Sulfur in fuel can poison the catalyst, reducing its effectiveness.
Aging and Degradation: Over time, the catalyst materials can degrade due to thermal cycling and contamination, reducing the converter's efficiency.
Limited Reduction of Certain Pollutants: While TWCs are highly effective at reducing NOx, CO, and HC, they do not significantly reduce particulate matter (PM) emissions. This is more of an issue in diesel engines, which typically use different types of catalytic converters like diesel oxidation catalysts (DOC) and diesel particulate filters (DPF).

Selective Catalytic Reduction (SCR) is an advanced emissions control technology used to reduce nitrogen oxide (NOx) emissions from diesel engines and industrial processes. It involves the injection of a reductant, typically ammonia (NH₃) or urea (CO(NH₂)₂), into the exhaust stream where it reacts with NOx in the presence of a catalyst to form harmless nitrogen (N₂) and water (H₂O). In SCR, a dosing system precisely injects the reductant into the exhaust stream. The amount injected is carefully controlled based on the engine load, temperature, and NOx levels. A catalyst, typically made of materials such as vanadium, titanium, and zeolites, facilitates the chemical reactions between the reductant and NOx. A control system monitors various parameters such as exhaust temperature, NOx levels, and reductant levels to ensure optimal operation of the SCR system. SCR systems are highly effective at reducing NOx emissions, typically achieving reductions of 70-90% or more.

Exhaust Gas Recirculation (EGR) is a technique used to reduce nitrogen oxide (NOx) emissions from internal combustion engines. It works by recirculating a portion of the engine's exhaust gas back into the intake manifold, where it mixes with the incoming air-fuel mixture. This dilutes the mixture, meaning there is less oxygen available for combustion. The presence of inert gases (such as CO2 and N2) in the intake charge absorbs the heat during combustion. This lowers the peak combustion temperatures, which in turn reduces the formation of NOx, as NOx formation is temperature dependent. This diluted mixture is then combusted in the engine cylinders. The EGR system is managed by the engine control unit (ECU), which adjusts the EGR valve based on engine load, speed, temperature, and other operating conditions. EGR systems can reduce NOx emissions by 40-60% in gasoline engines and by 20-50% in diesel engines, depending on the design and operating conditions. While it has certain limitations, such as potential impacts on engine performance and increased particulate emissions in diesel engines, EGR remains a valuable tool in the overall strategy to control NOx emissions. When combined with other emission control technologies, EGR helps vehicles meet stringent environmental regulations and contributes to cleaner air.

Catalytic converters, selective catalytic reduction, and exhaust gas recirculation are all focused on treating the exhaust gasses-still allowing the formation of NOx.

Oxygen concentrators are medical devices that assist people who have a low level of oxygen in their blood by providing them with concentrated oxygen. The oxygen concentrator receives air, filters it, and distributes the newly formed gas mixture. Atmospheric air is comprised of 78% nitrogen and 21% oxygen. Pressure Swing Adsorption (PSA) is a key technology used in oxygen concentrators to separate oxygen from nitrogen and other gases in the air. PSA operates based on the principle that gases can be adsorbed under high pressure and released under low pressure. The process relies on a material called zeolite, which has a high affinity for nitrogen. Zeolite is a highly microporous material with a complex crystalline structure. Zeolite's microscopic pores, measuring between 0.3 and 1.5 micrometers, act like a network of tunnels, giving zeolites the ability to adsorb molecules of different sizes, shapes, and affinity. The pores allow for efficient separation of larger molecules from smaller molecules.

In an oxygen concentrator, atmospheric air (ambient air to the vehicle) is first drawn into the oxygen concentrator and compressed to a higher pressure using a compressor. The compressed air passes through filters to remove impurities and particulates. Next, the compressed air enters a sieve bed filled with zeolite. Under high pressure, zeolite adsorbs nitrogen molecules more readily than oxygen due to their smaller size. Oxygen molecules, which are larger, pass through the sieve bed and are collected as the product gas. The result is a stream of concentrated oxygen (typically around 90-95% pure) and a nitrogen-rich gas that is adsorbed by zeolite. After a certain period, the pressure in the sieve bed is reduced to atmospheric pressure. The reduction in pressure causes the zeolite to release the adsorbed nitrogen, which is then vented out of the concentrator. This step regenerates the zeolite, making it ready for the next adsorption cycle. The alternating operation of the two sieve beds ensures that while one bed is adsorbing nitrogen and producing oxygen, the other is regenerating. This allows for a continuous flow of oxygen to the patient. PSA technology efficiently separates oxygen from nitrogen without the need for chemicals or high temperatures. It provides a consistent and reliable source of concentrated oxygen. The technology is compact enough to be used in portable oxygen concentrators for home or travel use. Regular maintenance involves cleaning or replacing filters to keep the system running efficiently. The zeolite material in the sieve beds can degrade over time and may need replacement depending on the usage and manufacturer's guidelines.

U.S. Pat. No. 8,176,884 places a zeolite filter (molecular sieve) inline in the intake manifold which filters out nitrogen from the incoming air before it enters the intake manifold. FIG. 1A shows a block schematic view of the internal combustion engine from the '884 patent. Atmospheric air enters the system through the intake inlet 101. An oxygen concentrator/generator (containing zeolite sieves) 102 draws in and removes nitrogen from the atmospheric air. The oxygen concentrator/generator 102 then provides supplemental concentrated oxygen to the intake manifold 106 through valve 103 or valve 104 where it joins with the atmospheric air stream (before or after an air filter 105). The joined stream is supplied to the internal combustion engine 107 to burn fuel and propel the vehicle. Exhaust gases, created by burning fuel, exit through the exhaust manifold 108 and pass through a catalytic converter 109 to remove NOx emissions. FIG. 1B outlines the process for the '884 patent. First, the oxygen concentrator draws in and removes nitrogen from the atmospheric air 151. Then supplemental concentrated oxygen joins the atmospheric air stream 152. Next, the joined stream is supplied to the internal combustion engine where it is burned with fuel 153. Exhaust gases then exit out the exhaust manifold 154 and pass through a catalytic convert 155. Finally, the remaining gases exit the system 156. While this method decreases NOx emissions, thereby enhancing overall emissions, efficiency, and performance, it merely supplements the atmospheric air with concentrated oxygen. The air entering the combustion chamber still contains a significant amount of nitrogen and still relies heavily on the catalytic converter.

U.S. Pat. No. 9,149,757 also placed zeolite filters inline in the intake manifold. A bypass valve and an extra intake track were fitted enabling the option of non-filtered operation of the engine. This disclosure enables an increase of pumping losses on the motor as it relies on the engine to suck air through the zeolite. Without a pressure swing mechanism, it would be difficult to release the adsorbed nitrogen.

The previously mentioned prior art systems focus on pre-treating the intake air to reduce nitrogen compounds, thereby decreasing the formation of NOx during combustion.

U.S. Patent Publications US20110005505 and US20110005504A1 both store compressed oxygen for subsequent, occasional use (injection) during cold start conditions to improve hydrocarbon emissions. The disclosed systems do alternate sieve beds to enable the zeolite to release adsorbed nitrogen, but cannot operate the engine continuously and cannot inject the oxygen directly into the cylinder in sufficient quantities to increase power output. These systems are also unable to make up for potential pressure drops in their system due to having only one compressor. They are also unable to directly inject into the cylinder due to a lack of direct oxidant injectors, limiting power production potential. These systems are only intended to operate in cold start conditions. By using a throttle to control engine speed, these systems result in pumping losses and poorer efficiency, as well as a lack of control over volumetric efficiency at lower engine speeds. These disclosures do not contemplate the disclosed tanks of the present invention or eliminating nitrogen from the system.

What is needed is a more effective and efficient system that is easier to manufacture, repair and maintain.

### BRIEF SUMMARY OF THE INVENTION

The Nitrogen Rejection System (NRS) is a component that attaches to an internal combustion engine system (or jet engine combustion system) to prevent nitrogen from entering the combustion chamber-thus reduce or eliminate NOx emissions and increase power production. A compressor draws in filtered atmospheric air (atmospheric air that has passed through the intake filter) and compresses it into a tank containing zeolite. This results in a tank of compressed concentrated oxygen which is then injected into the engine. In comparison to prior art zeolite systems in the intake manifold, the NRS can: (1) more accurately control the amount of oxygen produced; (2) produce oxygen more efficiently; and (3) produce compressed output—allowing for very high-power production potential. The NRS also allows for oxygen production when the vehicle is off, by means of a secondary power source. This enables the vehicle to have oxygen ready to go when the car is restarted. The NRS also allows non-filtered operation of the engine, when needed. Because the zeolite is all in the tank, only a simple (bypass) valve is needed. Using a tank also simplifies maintenance and repair. The tank can simply be removed without having to undo a plethora of intake piping.

### BRIEF DESCRIPTION OF THE DRAWINGS

Illustrated in the accompanying drawing(s) are embodiments of the present invention in such drawings:

FIG. 1A shows a first prior art zeolite system layout;

FIG. 1B shows the first prior art zeolite process;

FIG. 2 shows a chart comparing different methods of fuel injection and their effects on engine performance;

FIGS. 3A and 3B show the system layout of the present invention;

FIG. 3C shows the process of the present invention;

FIG. 4 shows a cross-section view of a compressed oxygen tank;

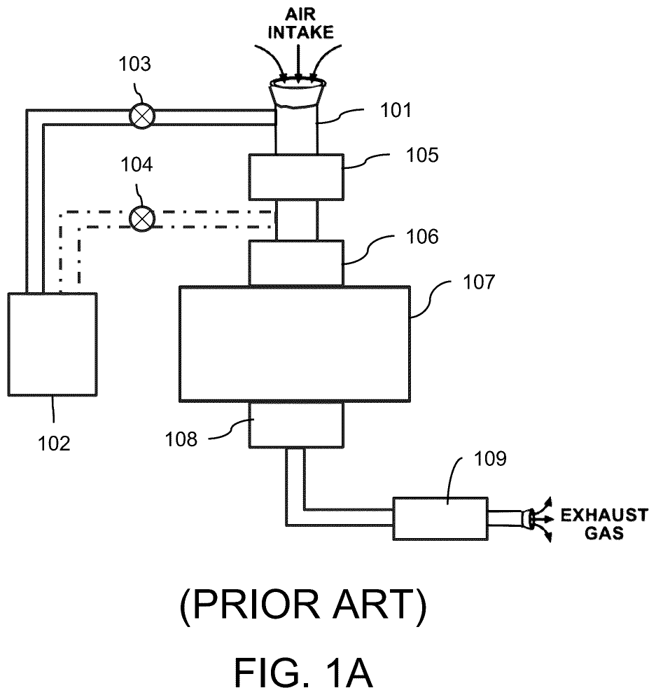

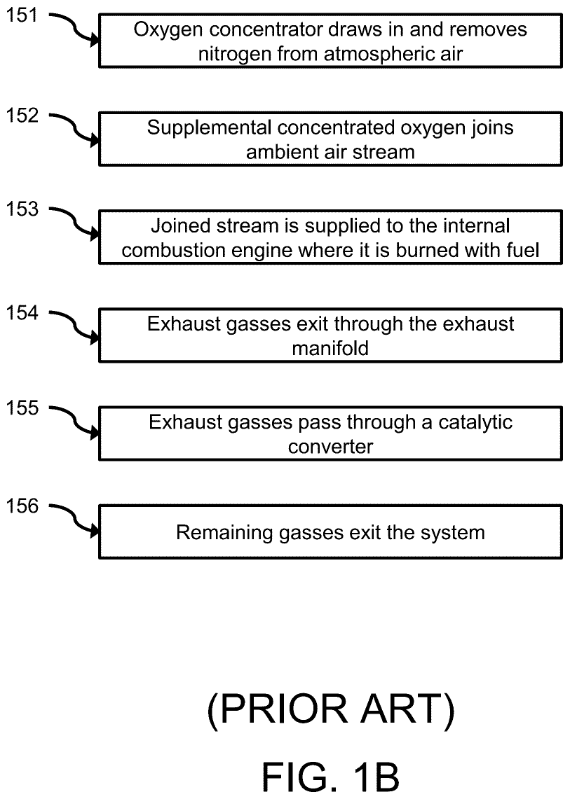

The above-described figures illustrate the described apparatus and its method of use in several preferred embodiments, which are further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

### DETAILED DESCRIPTION OF THE INVENTION

Despite the growing momentum towards electric vehicles and renewable energy sources, internal combustion engines (ICEs) are expected to remain a significant part of the global transportation landscape for the foreseeable future. This persistence is due to their established infrastructure, relatively low cost, and continued advancements in efficiency and emissions control. As long as ICEs are in use, it is crucial to address their environmental impact, particularly the emissions of nitrogen oxides (NOx), which are harmful pollutants contributing to smog and respiratory problems. Strategies to mitigate NOx emissions include advanced catalytic converters, exhaust gas recirculation (EGR), and the development of low-NOx emitting fuels. However, the most effective approach involves preventing the formation of NOx during the combustion process itself, through technologies like lean burn engines, optimized air-fuel mixtures, and innovative combustion techniques. Continuous innovation in these areas is essential to minimize the environmental footprint of ICEs while they remain a prevalent technology.

For combustion, three essential components are required: oxygen, fuel, and an ignition source. In an internal combustion engine operating on gasoline, the engine's power output is directly correlated to the rate at which it can consume air. Given that air is composed of approximately 21% oxygen, this correlation is crucial as the quantities of fuel and air must be appropriately matched. This precise ratio is known as the Air-Fuel Ratio (AFR). For gasoline engines, the AFR is 14.7:1, meaning 14.7 kilograms of air are required for every kilogram of gasoline to achieve efficient combustion. Engines may deviate from this ratio under varying operational conditions.

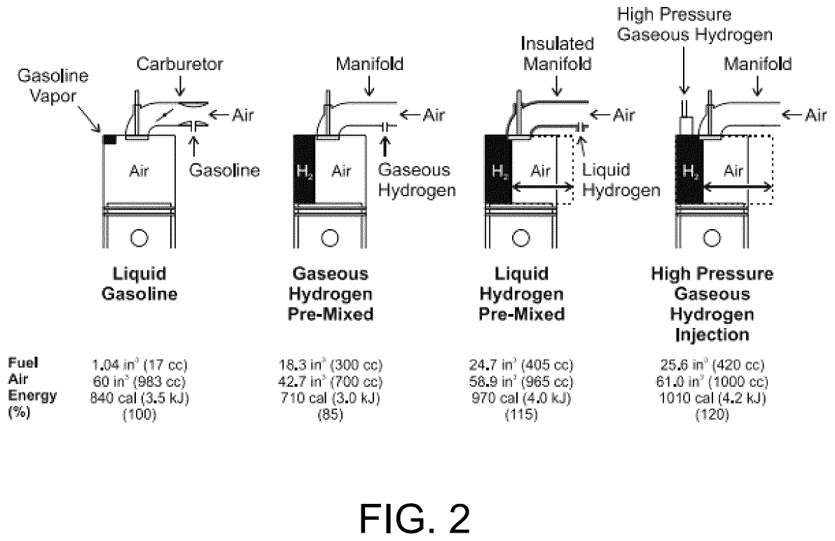

In contrast, hydrogen-fueled engines have an AFR of 34:1, indicating that 34 kilograms of air are needed for every kilogram of hydrogen. This presents a significant challenge due to hydrogen's low energy density and high air consumption requirements. Consequently, a port-injected engine running on hydrogen cannot generate the same power output as it would with gasoline. The need for higher air intake in hydrogen combustion reduces the overall efficiency and power generation in a port-injected configuration compared to gasoline engines. This is demonstrated in FIG. 2 (Lanz, Andre. “Module 3: Hydrogen Use in Internal Combustion Engines.” Hydrogen Fuel Cell Engines and Related Technologies, College of the Desert, 2001, pp. 3-7) which shows a chart comparing different methods of fuel injection and their effects on engine performance.

As illustrated in the second cylinder of FIG. 2, the volume of air within the cylinder is reduced due to the increased space occupied by hydrogen. In a carbureted gasoline engine with a displacement of 1000 cc (1 liter), only 17 cc is utilized by the fuel, leaving the remaining 983 cc available for air. Given that air comprises 21% oxygen, this translates to 206.43 cc of oxygen. Conversely, in the hydrogen engine (the second engine), 300 cc is occupied by the fuel, leaving 700 cc for air, which equates to 147 cc of oxygen.

Oxygen is crucial because it reacts with the fuel to produce energy. The reduced amount of oxygen in the hydrogen engine means less efficient combustion, leading to lower energy output. This difference is significant because efficient combustion requires an optimal mix of fuel and oxygen. More oxygen in the mixture allows for more fuel to be injected, allowing for higher power production.

When examining the energy content, the gasoline system generates 840 calories, whereas the hydrogen engine produces 710 calories. This discrepancy suggests that engines would need to be significantly larger and heavier to match the power output achieved with gasoline. However, this is not necessarily the case. The second engine demonstrates a hydrogen engine employing port injection, whereas the fourth diagram illustrates direct injection.

Direct injection delivers fuel directly into the combustion chamber, bypassing the reliance on the intake stroke to mix fuel with air. This method allows for more precise control of the Air-Fuel Ratio (AFR) and enables greater power output from the same engine displacement. As shown, the direct injection hydrogen engine surpasses the performance of both carbureted and port-injected gasoline engines.

The present invention, the Nitrogen Rejection System (NRS), enables feeding the engine with a nearly pure, or concentrated, oxygen gas mix. The present invention prevents nitrogen from entering the combustion chamber by removing it as it flows through (or into) a compression tank that will hold compressed filtered oxygen. Instead of the 1000 cc of air of FIG. 2 (with 210 cc oxygen and 790 cc nitrogen), the present invention enables 1000 cc of oxygen which is 4.76× the original amount (210 cc) of oxygen in the intake air. To maintain the AFR, injecting 4.76× the amount of hydrogen is then 1999.2 cc of hydrogen-resulting in 4807.6 cal of energy. This is roughly 5× the power output from the same displacement engine. Further, no longer having energy losses from heating unwanted nitrogen will result in further mechanical and thermal efficiency gains.

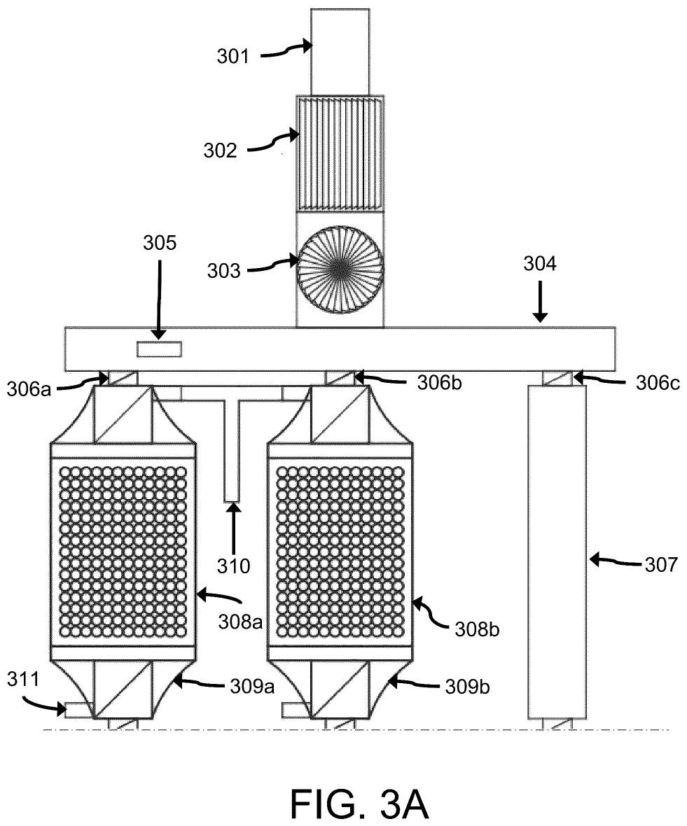

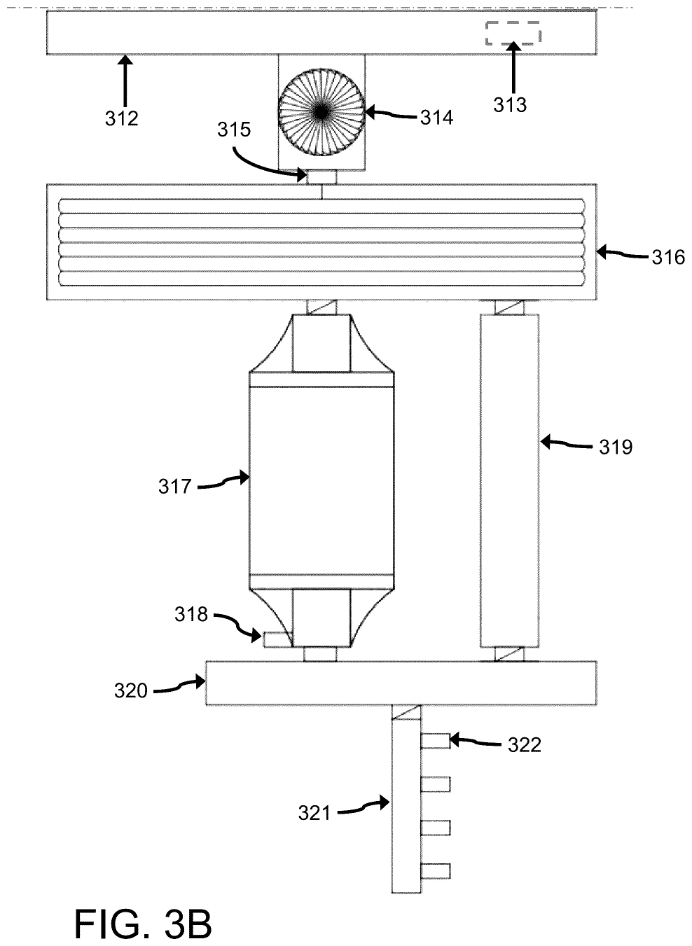

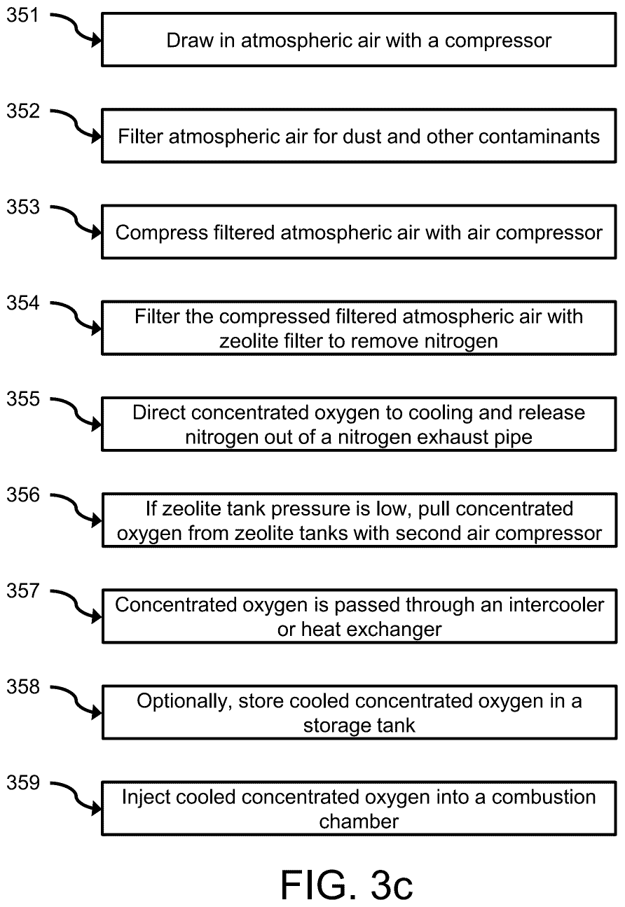

FIGS. 3A and (continued in) FIG. 3B show the present invention system layout. Atmospheric air first flows into an air intake tube 301 such as Toyota 17753-0T030. The intake tube 301 is positioned for minimal drag and maximum flowrate to the air compressor 303. The intake tube 301 is located in a standard airbox, equipped with a standard automotive engine air filter such as Toyota 17801-77050, typically made of either fabrics or paper. Air filter 302 protects the air intake system from dust and other contaminants. An electrically or mechanically driven air compressor 303 such as Toyota 17A1077041 compresses the filtered atmospheric air to high pressures (e.g., X psi). Air compressor 303 can be a centrifugal style compressor, twin screw, or any number of mechanical compressors that are well suited to high flow rates. Butterfly valves 306a, 306b, 306c control the flow of the compressed filtered atmospheric air via a branched pathway of charge piping (reinforced intake tubes) 304 such as Toyota 17361-18021. Charge piping 304 contains pressure sensors 305, such as Toyota 89421-06020 or Bosch DS-G3-TF, which are needed to determine whether to open and shut each valve and help determine optimal compressor speeds. Valves 306a, 306b, and 306c may be throttle body style or other flow valves such as Toyota 22030-18010 depending on the size of the engine and necessary flow rate. Electronic solenoid valves may also be used. Valve 306c is controlled by the ECU (not shown), enables the compressed and filtered atmospheric air to bypass the invention through bypass pipe 307, such as Toyota 17362-18010, and proceed to the cooling step (discussed later) where it can be injected into the engine. The compressed filtered atmospheric air can be used in the event that there is a zeolite failure, valve failure, nitrogen exhaust blockage, low power state, compressor failure or other potential errors that could stop the flow/production of the concentrated oxygen from zeolite tanks 308a and 308b (discussed below).

Through valves 306a and 306b, Zeolite tanks 308a and 308b, filled with zeolite pellets, remove nitrogen from the compressed filtered atmospheric air. The compressed atmospheric air is forced into a series of tanks 308a, 308b where the nitrogen in the compressed air is adsorbed by the zeolite pellets, such as CalciumLSX. This results in a large volume and pressure decrease. If the pressure is high enough, the new oxygen-rich gas will be directed to the cooling step (discussed later). During low intensity operation, the pressure of the oxygen gas mixture (sensed by tank pressure sensor 311) may drop low enough to trigger the operation of the second compressor 314. This is determined by the ECU and depends on the efficacy of the zeolite, the age of the system, design/space constraints, operating intensity, and efficiency concerns. This is determined by the ECU and depends on the efficacy of the zeolite, the age of the system, design/space constraints, operating intensity, and efficiency concerns.

Concentrated oxygen, oxygen having a high oxygen content, exits the zeolite tanks out of tank valves 309a and 309b, such as Toyota 22030-18010. Tank valves 309a and 309b can shut to store the air/oxygen gas mixture for however long is necessary so that upon starting the car, concentrated oxygen is immediately available to get the car going, rather than relying on atmospheric air. Further, tank valves 309a and 309b are needed to switch between the tanks to enable the pressure swing mechanism function. The ECU controls the opening and closing of valves 309a and 309b using data from boost pressure sensors 313, mass flow sensors 305, and tank pressure sensors 311. The unwanted captured nitrogen exits the tank out of the nitrogen exhaust pipe 310, a standard pipe such as Toyota 17362-18010.

If necessary (if the pressure in the zeolite tanks is too low to effectively discharge the concentrated oxygen), a second air compressor 314 will pull air from the zeolite tanks and force it into the charge tubing 312, allowing for more consistent and sustainable performance. If necessary, the entire system can run on only one compressor but may need to use unfiltered atmospheric air at times such as cold starts, or engine starts where the vehicle lays dormant for long periods.

The concentrated oxygen is then passed through either an intercooler or heat exchanger 316 such as Toyota 17940-18030. Intercoolers allow for the cooling of the compressed air/compressed oxygen-rich gas by dissipating heat into the atmosphere. Heat exchangers transfer heat from the compressed air/compressed oxygen-rich gas to a working fluid, such as engine coolant.

Storage tank 317 (optional), such as Air Liquide Cylinder Size 16, can be placed in line and stores the concentrated oxygen. A storage tank would be useful in situations where the zeolite tanks did not have the opportunity to acquire operating pressures, such as when the vehicle is started, shut off and immediately started again. A storage tank, however, would occupy additional space and may add unwanted weight to the vehicle.

Oxygen rail 321, a modified fuel rail, such as Toyota 2381424011, is a pipe with holes where the direct oxidant injectors 322 are mounted. Direct oxidant injectors may also be mounted to high pressure hoses (not shown) which mount to the oxygen rail holes. Direct oxidant injectors 322, such as the Bosch NGI2, are modified high-flow fuel injectors that inject concentrated oxygen into the combustion chamber. Controlled by the ECU (not shown), these injectors fire at specific stages of the engine cycle to deliver the oxidant directly where it is needed. The exact size and shape of the injectors will vary with the displacement and arrangement of the engine but will be direct injectors—a gas or liquid injector that sprays fuel or oxidizer directly into a combustion chamber.

Sensors placed at various points in the system enable the ECU (not shown) to determine when to open and shut valves and the amount of oxidizer to supply to the combustion chamber(s). This allows the ECU to ensure the NRS is always providing optimal amounts and pressures of filtered gas, optimal engine start conditions and monitors oxygen concentrations to monitor the health of the zeolite. Mass air flow sensors 305, such as Toyota 22204-75040, mounted in the intake charge piping 304, sense the flow rate of atmospheric air and filtered gas, to ensure they are always at the correct levels for efficient combustion. Boost pressure sensor 313, such as Bosch DS-G3-TF, ensures the system is producing adequate pressure for oxygen direct injection. Boost pressure sensor 313 is mounted in the charge piping 312 located after the zeolite tanks 308a, 308b. Tank pressure sensor 311, such as Accuair AA-3677, monitors the pressure in the zeolite tanks 308a, 308b to control valve open/close timing, to ensure steady flow of oxygen production is achieved.

The basic process of the NRS is shown in FIG. 3C. Atmospheric air is drawn in by an air compressor 351. The atmospheric air is then filtered for dust and other contaminants 352. The filtered atmospheric air is then compressed by an air compressor 353. The compressed filtered atmospheric air then passes through a zeolite filter to separate nitrogen from oxygen 354. The concentrated oxygen is directed to cooling and the separated nitrogen is released into the atmosphere through a nitrogen exhaust pipe 355. If the pressure in the zeolite tanks is too low to effectively discharge the oxygen, a second air compressor pulls the concentrated oxygen from the zeolite tanks 356. The concentrated oxygen is then passed through either an intercooler or heat exchanger to cool the concentrated oxygen 357. Optionally, the cooled concentrated oxygen can be stored in a storage tank 358. Inject cooled concentrated oxygen into a combustion chamber 359.

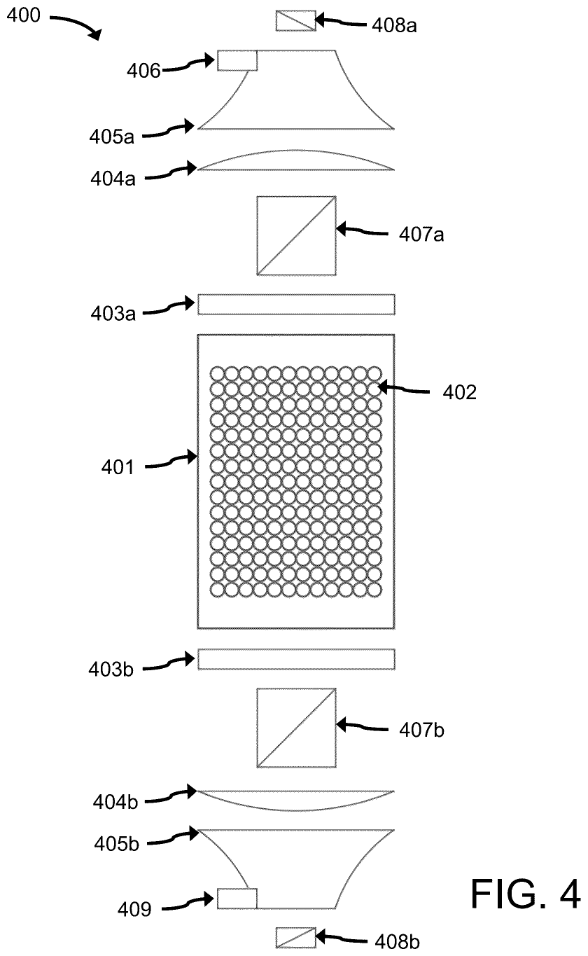

FIG. 4 shows an exploded view of a zeolite tank 400. A tank 401 with two removable lids 404a, 404b is constructed of a regular pressure cylinder, such as Air Liquide Cylinder Size 16, with the ends cut off. Welded threads are used to secure the removable lids 404a, 404b to the tank 401. A mesh retainer holds zeolite material 402 between two stainless steel meshes 403a, 403b. The zeolite material 402 is placed such that all the compressed filtered atmospheric air must pass through it. Stainless steel is used for the meshes 403a, 403b due to the potentially high humidity and higher temperatures in the tank. The mesh pore size is smaller than the zeolite pellet 402 size to prevent nitrogen from escaping. It is crucial that the retainer meshes (containment meshes) 403a, 403b do not fail as failure could result in the mesh material or the zeolite 402 itself blocking components downstream, or worse, being ingested by the engine. Each mesh 403a, 403b is cut to match the inner diameter of the lids 404a, 404b, such as Horuhue 304 stainless steel mesh—a wire mesh with 1 mm openings and 0.4 mm thick wire. Each of the mesh retainers 403a, 403b has a retaining ring made of plastic (not shown) that is attached to the stainless steel with a resin. The plastic retaining ring has threads that allow each mesh retainer 403a, 403b to be threaded into the removeable lids 404a, 404b. Rubber isolators 405a, 405b are preferably made of vulcanized rubber with a plastic frame (not shown) underneath similar to a standard engine/transmission mount, made with plastic rather than metal, such as Toyota SU003-01005. The vulcanized rubber isolates the tank from vehicle vibrations and protects the tank in case of a drop during maintenance. The plastic frame adds rigidity to the vulcanized rubber isolators 405a, 405b. Valve and bottle threads 407a, 407b are integrated with the removable lids 404a, 404b. Valve and bottle threads 407a, 407b and rubber isolators 405a, 405b are threaded together and installed on to the tank 401 by threading the parts together. Exhaust valve 406, such as Atlantic Valve BCM-10, vents unwanted nitrogen back into the atmosphere. A secondary valves 408a, 408b, such as Atlantic Valve BCM-10, allows the ECU to stop the flow of gas and store the gas at pressure within the tank. Exhaust valve 406 and secondary valves 408a, 408b are attached to the tank 401 by sections of charge pipe (not shown). A tank pressure sensor 409, such as Accuair AA-3677, is used to sense and send the tank pressure to the ECU so that the ECU can determine if it is necessary to run a second air compressor to pull air from the zeolite tanks to allow for more consistent and sustainable performance.

The zeolite tanks of the present invention facilitate simpler maintenance. Dealers can simply swap tanks and send them to a refurbishment center. This enables decreased customer waiting time-instead of opening the tubing and manually swapping out the zeolite.

It is important to point out that this invention does not rely on the intake stroke of the engine to pull atmospheric air into cylinders. Instead, air compressors feed direct injectors that inject air into the cylinder. By using electric compressors instead of the engine itself, there is less parasitic drag on the engine. This also enables elimination of the valve train responsible for driving the opening and closing of the intake valve. This increases efficiency and reduces points of failure. It also enables the possibility to inject oxygen at a pressure greater than atmospheric pressure, forcing more cc into the same volume and enabling injection of more fuel. This would, however, require updated engine components to handle the additional forces.

In one embodiment, pressure swing absorption is used by alternating tanks. In another embodiment only one zeolite tank is used. The advantages of using a single zeolite tank include a simpler design with fewer components, which simplifies maintenance and reduces initial costs. Its smaller size enables a more lightweight design, resulting in fuel savings. However, the disadvantages of a single zeolite tank include reduced efficiency, longer cycle times, fluctuations in purity, lower overall purity, and limited capacity.

While the specification is primarily directed to internal combustion engines, the invention can also be used with jet turbines, external combustion engines and open-flame equipment, heat engines, cars, piston driven aircraft, boats, ships, drones, trains, and the like.

The drawings, the description, and the claims contain numerous features in combination. It will be appreciated that the aforementioned features are applicable not only in the respectively specified combination but also in other combinations or on their own, without departing from the scope of the present invention.

I claim:

1. A system, the system comprising:
a first tank, the first tank comprising a first internal zeolite filter; and
a compressor, the compressor for compressing filtered atmospheric air into the first tank through the first internal zeolite filter to create a concentrated oxygen, the concentrated oxygen for injecting into a combustion chamber of a combustion engine in conjunction with a fuel.

2. The system of claim 1, further comprising:
an engine control unit logic configured to control one or more amounts of concentrated oxygen to inject into the combustion chamber.

3. The system of claim 1, further comprising:
a power source, the power source configured to provide power to one or more of:
a compressor-filter system, the compressor-filter system configured to compress and filter the filtered atmospheric air when the combustion engine is in an off state;
one or more sensors;
one or more gas valves;
a heat exchanger; and
one or more direct oxidant injectors, the one or more direct oxidant injectors for injecting the concentrated oxygen into the combustion chamber.

4. The system of claim 3, wherein the power source is one of: a fuel cell or a battery.

5. The system of claim 3, wherein the sensors comprise one or more of:
a tank pressure sensor;
a mass flow sensor; and
a boost pressure sensor.

6. The system of claim 1, further comprising:
a tank bypass valve.

7. The system of claim 1, further comprising:
a second tank, the first and second tank arranged in a pressure swing style arrangement, wherein the compressor alternates between compressing filtered atmospheric air into the first tank through the first internal zeolite filter to create the concentrated oxygen and into the second tank through a second internal zeolite filter to create a second concentrated oxygen, wherein the second concentrated oxygen is for injecting into the combustion chamber in conjunction with the fuel.

8. The system of claim 1, further comprising:
an excess storage tank to store the concentrated oxygen.

9. The system of claim 8, wherein the excess storage tank stores the second concentrated oxygen.

10. The system of claim 1, further comprising:
a tank pressure sensor, the tank pressure sensor configured to sense a tank pressure, the tank pressure sensor in communication with an engine control unit; and
a second compressor, wherein the engine control unit activates second compressor upon determination of a low tank pressure.

11. A method, comprising:
compressing, using a compressor, filtered atmospheric air into a first tank through a first internal zeolite filter creating a concentrated oxygen; and
one or more of:
injecting, using one or more injectors, the concentrated oxygen into a combustion chamber in conjunction with a fuel; and
storing, in an excess storage tank, the concentrated oxygen.

12. The method of claim 11, further comprising:
controlling, using an engine control unit logic, one or more amounts of concentrated oxygen to inject into the combustion chamber.

13. The method of claim 11, further comprising:
providing power, using a power source, to one or more of:
a compressor-filter system, the compressor-filter system configured to compress and filter the filtered atmospheric air when the combustion engine is in an off state;
one or more sensors;
one or more gas valves;
a heat exchanger; and
one or more direct oxidant injectors, the one or more direct oxidant injectors for injecting the concentrated oxygen into the combustion chamber.

14. The method of claim 13, wherein the power source is one of: a fuel cell or a battery.

15. The method of claim 13, wherein the sensors comprise one or more of:
a tank pressure sensor;
a mass flow sensor; and
a boost pressure sensor.

16. The method of claim 11, further comprising:
directing filtered atmospheric air to avoid the first tank using a tank bypass valve.

17. The method of claim 11, further comprising:
alternating between compressing filtered atmospheric air into the first tank through the first internal zeolite filter and into a second tank through a second internal zeolite filter to create a second concentrated oxygen, the first and second tank arranged in a pressure swing style arrangement, wherein the second concentrated oxygen is for injecting into the combustion chamber in conjunction with the fuel.

18. The method of claim 11, further comprising:
storing the concentrated oxygen in an excess storage tank.

19. The method of claim 18, further comprising:
storing the second concentrated oxygen in an excess storage tank.

20. The method of claim 11, further comprising:
sensing a tank pressure using a tank pressure sensor, the tank pressure sensor in communication with an engine control unit; and
detecting a low tank pressure by the engine control unit; and
activating a second compressor by the engine control unit.
